(19) United States
(12) Patent Application Publication
(10) Pub. No.: US 2023/0101308 A1
(43) Pub. Date: Mar. 30, 2023

(54) IMAGING IOT PLATFORM UTILIZING FEDERATED LEARNING MECHANISM

(71) Applicant: Konica Minolta Business Solutions U.S.A., Inc., San Mateo, CA (US)

(72) Inventor: Jun Amano, Hillsborough, CA (US)

(73) Assignee: Konica Minolta Business Solutions U.S.A., Inc., San Mateo, CA (US)

(21) Appl. No.: 17/490,086

(22) Filed: Sep. 30, 2021

(51) Int. Cl. G06K 9/00; G06N 3/04; H04L 29/08

(52) U.S. Cl. CPC G06K 9/00979; G06N 3/04; G06K 9/00771; H04L 67/12

(57) ABSTRACT

A cloud server is connected to a plurality of edge devices via a network, and includes: a storage that stores a common machine learning (ML) model that is pretrained and used for optimizing image analysis; and a processor that repeatedly executes: distributing the common ML model to each of the edge devices that optimize the image analysis using local data and that modify the common ML model to create a locally optimized ML model, collecting a key parameter of an optimization result, without collecting the locally optimized ML model or accessing the local data, from each of the edge devices, and updating the common ML model stored in the storage by reflecting the key parameter in the common ML model at a predetermined timing to continuously improve the common ML model for more accurate image analysis.

### BACKGROUND

### Technical Field

The present invention generally relates to an imaging Internet of Things (IoT) platform that utilizes a federated learning (FL) mechanism and provides advanced vision-based artificial intelligence (AI)/machine learning (ML) tools to users while protecting users' data privacy.

### Description of Related Art

Imaging IoT platforms provide users with vision-based AI/ML tools in fields of image analysis for medical diagnosis, human behavior analysis, security control, etc. Recently, there has been a rising demand in the imaging IoT platforms for protecting data privacy of users without impairing user convenience.

Meanwhile, conventional FL mechanisms have been used as a distributed learning paradigm where some users collaborate to build a common ML model in a distributed state without centrally collecting local data.

### SUMMARY

One or more embodiments of the invention provide an imaging IoT platform implemented with an IoT system that comprises a cloud server and edge devices/servers and realizes an FL mechanism with a robust common ML model by continuously improve the common ML model while protecting data privacy of the edge devices/servers.

One or more embodiments provide a cloud server connected to a plurality of edge devices via a network, the cloud server comprising: a storage that stores a common machine learning (ML) model that is pretrained and used for optimizing image analysis; and a processor that repeatedly executes: distributing the common ML model to each of the edge devices that optimize the image analysis using local data and that modify the common ML model to create a locally optimized ML model, collecting a key parameter of an optimization result, without collecting the locally optimized ML model or accessing the local data, from each of the edge devices, and updating the common ML model stored in the storage by reflecting the key parameter in the common ML model at a predetermined timing to continuously improve the common ML model for more accurate image analysis.

One or more embodiments provide a non-transitory computer readable medium (CRM) storing computer readable program code executed by a computer as a cloud server being connected to a plurality of edge devices via a network, and the program code causing the computer to execute: storing, in a storage, a common machine learning (ML) model that is pretrained and used for optimizing image analysis; and repeatedly executing: distributing the common ML model to each of the edge devices that optimize the image analysis using local data and modify the common ML model to create a locally optimized ML model, collecting a key parameter of an optimization result, without collecting the locally optimized ML model or accessing the local data, from each of the edge devices, and updating the common ML model stored in the storage by reflecting the key parameter in the common ML model at a predetermined timing to continuously improve the common ML model for more accurate image analysis.

One or more embodiments provide a federated learning (FL) method using a cloud server being connected to a plurality of edge devices via a network, the method comprising: storing, in a storage, a common machine learning (ML) model that is pretrained and used for optimizing image analysis; and repeatedly executing: distributing the common ML model to each of the edge devices that optimize the image analysis using local data and modify the common ML model to create a locally optimized ML model, collecting a key parameter of an optimization result, without collecting the locally optimized ML model or accessing the local data, from each of the edge devices, and updating the common ML model stored in the storage by reflecting the key parameter in the common ML model at a predetermined timing to continuously improve the common ML model for more accurate image analysis.

### BRIEF DESCRIPTION OF THE DRAWINGS

FIG. 1 is a schematic view of an IoT system according to one or more embodiments of the invention.

FIG. 2 is a hardware diagram of the IoT system according to one or more embodiments.

FIG. 3 is a conceptual diagram of an FL mechanism according to one or more embodiments.

FIG. 4 is a conceptual diagram of the FL mechanism according to one or more embodiments.

FIG. 5 is a conceptual diagram of the FL mechanism according to one or more embodiments.

FIG. 6 is a conceptual diagram of the FL mechanism according to one or more embodiments.

FIG. 7 is a flowchart showing an FL method for building a rubust common ML model according to one or more embodiments.

FIG. 8 is a computing system according to one or more embodiments.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Although multiple dependent claims are not introduced, it would be apparent to one of ordinary skill that the subject matter of the dependent claims of one or more embodiments may be combined with other dependent claims.

### Imaging IoT Platform

One or more embodiments of the invention provide an ecosystem consisting of an imaging IoT platform, a common ML model (i.e., imaging AI algorithm), and sensing devices (e.g., smart cameras). The imaging IoT platform provides users (e.g., business partners and customers) of the edge devices/servers with software development kits (SDKs) including an API document, sample code, test program, etc., and enables contactless, remote, and real-time responses in various types of business in fields of image analysis for medical diagnosis, human behavior analysis, security control, etc.

### IoT System

In one or more embodiments, the imaging IoT platform is implemented with an IoT system that comprises a cloud server and edge devices/servers and that realizes an FL mechanism with a robust common ML model by continuously improving the common ML model while protecting data privacy of the edge devices/servers.

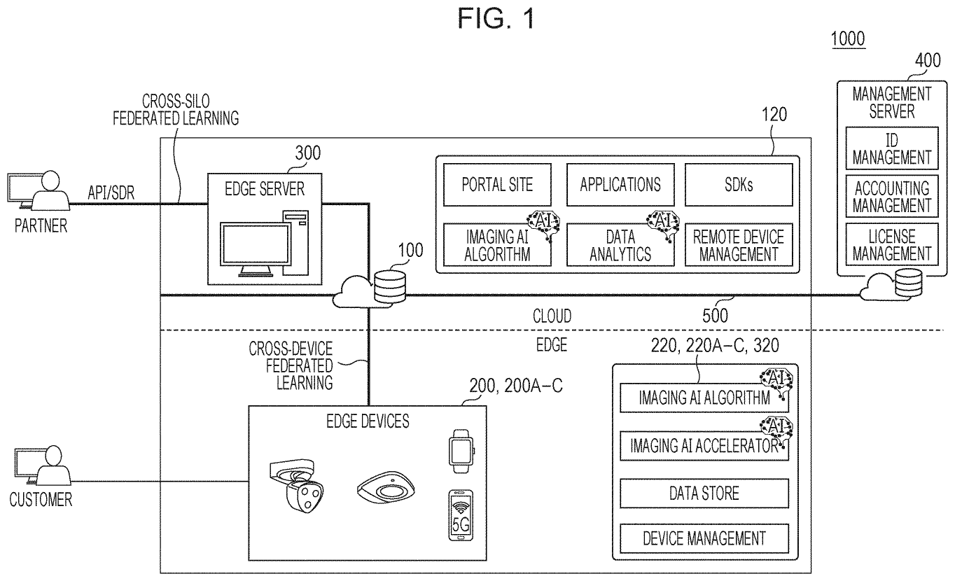

FIG. 1 is a schematic view of an IoT system 1000 according to one or more embodiments of the invention. The IoT system 1000 comprises: a cloud server 100; a plurality of edge devices 200; a client server 300; and a management server 400, which are connected to a network 500 (e.g., a wide area network (WAN) such as the Internet) via a network interface connection (not shown).

The cloud server 100 of one or more embodiments is a virtual server provided in a cloud environment and may be implemented with a physical server (e.g., personal computer (PC)) owned by a company providing the business partners and customers with the SDKs.

The edge devices 200 of one or more embodiments are used by the customers and include sensing devices (e.g., a security camera, monitoring camera, smartwatch, etc.) and portable devices (e.g., a smartphone, tablet, laptop, etc.) connected to the sensing devices.

The edge server 300 of one or more embodiments is a server (e.g., PC) owned by the business partner of the company, and may have a higher performance and a larger data capacity than those of the edge devices 200.

The management server 400 of one or more embodiments is a virtual server implemented with a physical server provided in the IoT system 1000, and cooperates with the cloud server 100 in the cloud environment.

The numbers of the edge devices 200, the edge server 300, and the management server 400 are not limited to the illustrated example, and the cloud server 100 may be further connected to another device/server within the network 500 or in another network.

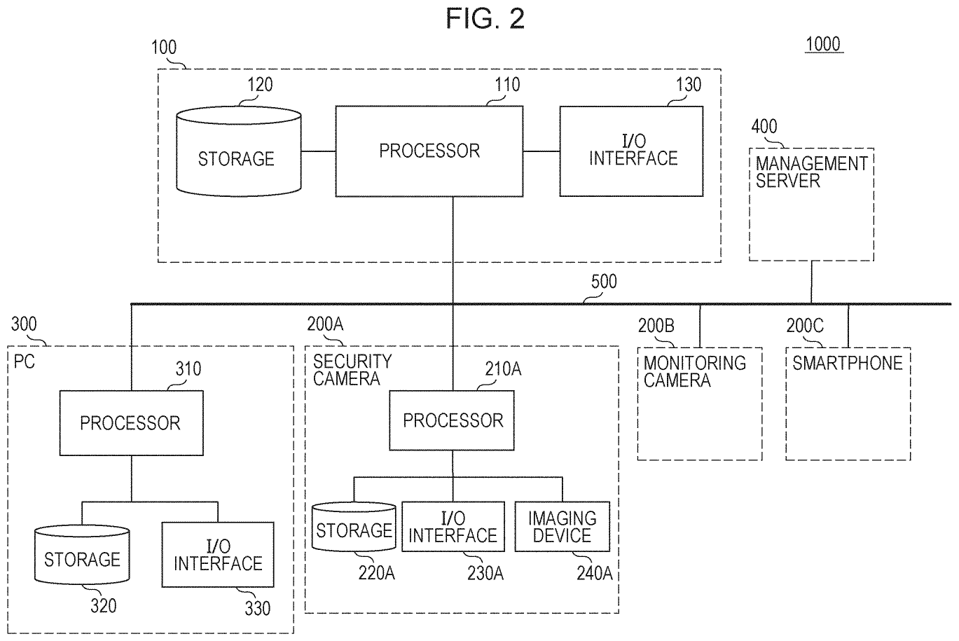

FIG. 2 is a hardware diagram of the IoT system according to one or more embodiments. The IoT system 1000 comprises: the cloud server 100; the edge devices 200A-200C (i.e., a security camera 200A, monitoring camera 200B, and smartphone 200C); the client server 300; and the management server 400, which are connected to one another via the network 500.

### Cloud Server

The cloud server 100 distributes the common ML model to each of the edge devices 200A-200C and/or the edge server 300. After the edge devices 200A-200C and/or the edge server 300 create a locally optimized ML model described later, the cloud server 100 collects a key parameter(s) of an optimization result(s) and updates the common ML model stored in the storage 120 by reflecting the key parameters to continuously improve the common ML model for more accurate image analysis.

The cloud server 100 comprises: a processor 110 that comprises a central processing unit (CPU) and AI/ML accelerator, such as field programmable gate array (FPGA), graphics processing unit (GPU), tensor processing unit (TPU), and application-specific integrated circuit (ASIC), random access memory (RAM), and read-only memory (ROM); a storage 120 such as a hard disk; and an input/output (I/O) interface 130 that may include an input device such as a touchscreen, keyboard, mouse, microphone, touchpad, electronic pen, or any other type of input device, and may also include an output device such as a screen (e.g. a liquid crystal display (LCD), a plasma display, touchscreen, cathode ray tube (CRT) monitor, projector, or any other display device), speaker, printer, external storage, or any other output device.

As illustrated in FIG. 1, the storage 120 stores, as the common ML model, an imaging AI algorithms for accurate image analysis. The common ML model is pretrained (or previously trained) and used for optimizing the image analysis executed in the edge devices 200A-200C and/or the edge server 300. The storage 120 may also store: AI applications for data analytics; remote device management applications; a portal site of the company; various kinds of other applications; and SDKs.

In one or more embodiments, the storage 120 stores a plurality of (different sizes and/or different kinds of) common ML models that are pretrained and used for optimizing the image analysis executed in the edge devices 200A-200C and/or the edge server 300.

Returning to FIG. 2, the processor 110 distributes the common ML model to each of the edge devices 200A-200C and/or the edge server 300. In one or more embodiments, in response to a request from one of the edge devices 200A-200C and the edge server 300, the processor 110 may select one of the common ML models to be distributed depending on the image analysis executed in the one of the edge devices 200A-200C and the edge server 300. This enables executing more appropriate image analysis to meet business partners' and/or customers' accuracy goals.

Based on the common ML model, each of the edge devices 200A-200C and the edge server 300 may optimize image analysis using local data stored therein and modify the common ML model to create a locally optimized ML model, as described later. After that, the processor 110 collects the key parameters of the optimization results, without collecting the locally optimized ML models or accessing the local data, from the edge devices 200A-200C and/or the edge server 300.

The processor 110 then updates the common ML model stored in the storage 120 by reflecting the key parameters in the common ML model at a predetermined timing to continuously improve the common ML model for more accurate image analysis. The predetermined timing is, for example, every predetermined time period or a timing of receiving an instruction input via the I/O interface 130 or an instruction sent from another device/server within the network 500 or in another network.

With regard to each of the edge devices 200A-200C, the processor 110 repeatedly executes the cycle of distributing the common ML model, collecting the key parameters, and reflecting the key parameters in the common ML model for continuous improvement. By this cross-silo or cross device FL, the processor 110 can build the robust common ML model while protecting data privacy of each of the edge devices 200A-200C.

Similarly, with regard to each of the client server 300, the processor 110 repeatedly executes the above cycle independently from the cycles of the edge devices 200A-200C, for continuous improvement. By this cross-silo or cross-server FL, the processor 110 can build the more robust common ML model while protecting data privacy of the client server 300.

In one or more embodiments, the processor 110 distributes, as the common ML model, a down-sized common ML model to each of the edge devices 200A-200C, while distributing the common ML model without downsizing to the edge server 300, as the edge server 300 may have the higher performance and the larger data capacity than those of the edge devices 200A-200C. The common ML model can be down-sized by data compression or other known software downsizing means.

### Edge Device

Based on the common ML model received from the cloud server 100, the edge devices 200A-200C optimize the image analysis using the local data stored therein and modifies the common ML model to create the locally optimized ML model.

Referring to FIG. 2, as one of the edge devices 200A-200C, the configuration and function of the security camera 200A will be described, while detailed explanations about the remaining edge devices 200B-200C (i.e., the monitoring camera 200B, smartphone 200C, etc.) are omitted as each of them may have similar configurations and functions to those of the security camera

The security camera 200A may be a smart camera that executes image processing such as real-time object detection and motion tracking using the local data. The security camera 200A comprises: a processor 210A that comprises a central processing unit (CPU), random access memory (RAM), and read-only memory (ROM); a storage 220A such as a hard disk; an input/output (I/O) interface 230A that may include an input device such as a microphone, and may also include an output device such as a speaker; and an imaging device 240A. In one or more embodiments, a processor 210A may contain AI/ML accelerator, such as field programmable gate array (FPGA), graphics processing unit (GPU), tensor processing unit (TPU), and application-specific integrated circuit (ASIC). In one or more embodiments, at least part of the I/O interface 230A may be omitted for miniaturization. The imaging device 240A comprises an imaging sensor such as charge-coupled device (CCD) sensor or a complementary metal-oxide semiconductor (CMOS) sensor, and captures images including still images and video images of the customers and backgrounds.

The security camera 200A may be connected to another device that is owned by the customers such as a personal computer (PC), a portable device including the smartphone 200C, or the like within the network 500. The security camera 200A may transmit the captured images to the other device, and may be controlled and/or managed by signals sent from the other device, via the network 500. In one or more embodiments, the other device may execute the functions of the processor 210A and the storage 220A instead of the security camera 200A.

As illustrated in FIG. 1, the storage 220A stores, as the locally optimized ML model, an imaging AI algorithm for executing accurate image analysis. In one or more embodiments, the locally optimized ML model is created by modifying the common ML model and is continuously optimized every time the image analysis is optimized based on the updated common ML model. In one or more embodiments, the image analysis is video image analysis for the real-time object detection and motion tracking. The storage 220A may also store: imaging AI acceleration applications (i.e., graphics accelerator applications); local data including images captured by the imaging device 240A; and device management applications.

Returning to FIG. 2, the processor 210A executes the image analysis of various heterogeneous vision data in a real-time using the common ML model, or using the locally optimized ML model if available, at the customers' sites.

Upon receiving the common ML model from the cloud server 100, the processor 210A optimizes the image analysis and modifies the common ML model to create the locally optimized ML model. The processor 210A also sends the key parameter(s) of the optimization result(s) to the cloud server 100 at a predetermined timing, for example, periodically or at a timing receiving a request from the cloud server 100.

In one or more embodiments, the processor 210A may include a graphics accelerator for accelerating image processing and image displaying on the I/O interface 230A.

It is needless to say the remaining edge devices 200B-200C may comprise additional components. For example, the smartphone 200C may comprise, as an I/O interface, an input device such as a touchscreen or any other type of input device, and an output device such as a screen (e.g. a liquid crystal display (LCD)) or any other output device.

### Edge Server

Similarly to the security camera 200A, based on the common ML model received from the cloud server 100, the edge server 300 optimizes the image analysis using the local data stored therein and modifies the common ML model to create the locally optimized ML model.

As illustrated in FIG. 2, the edge server 300 comprises: a processor 310 that comprises a central processing unit (CPU), random access memory (RAM), and read-only memory (ROM); a storage 320 such as a hard disk; and an input/output (I/O) interface 330 that may include an input device such as a touchscreen, keyboard, mouse, microphone, touchpad, electronic pen, or any other type of input device, and may also include an output device such as a screen (e.g. a liquid crystal display (LCD), a plasma display, touchscreen, cathode ray tube (CRT) monitor, projector, or any other display device), speaker, printer, external storage, or any other output device. In one or more embodiments, a processor 310 may contain AI/ML accelerator, such as field programmable gate array (FPGA), graphics processing unit (GPU), tensor processing unit (TPU), and application-specific integrated circuit (ASIC).

It is needless to say that the edge server 300 may comprise other components that a general PC comprises. In one or more embodiments, the edge server 300 may also comprise an imaging device having a similar structure and function to those of the imaging device 240A and/or may be connected to the sensing devices such as the security camera 200A and the monitoring camera 200B to receive the captured images via the network 500.

The processor 310 may function similarly to the processor 210A of the security camera 200A. Specifically, the processor 310 executes image analysis of various heterogeneous vision data in a real-time, optimizes the image analysis, and creates the locally optimized ML model. The processor 310 also sends the key parameter(s) of the optimization result(s) to the cloud server 100 at the predetermined timing.

### Management Server

The management server 400 cooperates with the cloud server 100 and manages IDs, accounting, and licenses of the business partners and the customers. For example, the management server 400 sends the IDs, accounting, and licenses to the cloud server 100 in response to a request from the cloud server 100.

The management server 400 may have a similar configuration and function to those of the cloud server 100 illustrated in FIG. 2. As illustrated in FIG. 1, the management server 400 may store ID management applications, accounting management applications, and license management applications in a storage.

### FL Mechanism

The IoT system 1000 implements the FL mechanism, which distributes the common ML model, created by the common algorithm such as a neural network (NN) or a deep neural network (DNN), using the common global dataset as listed below.

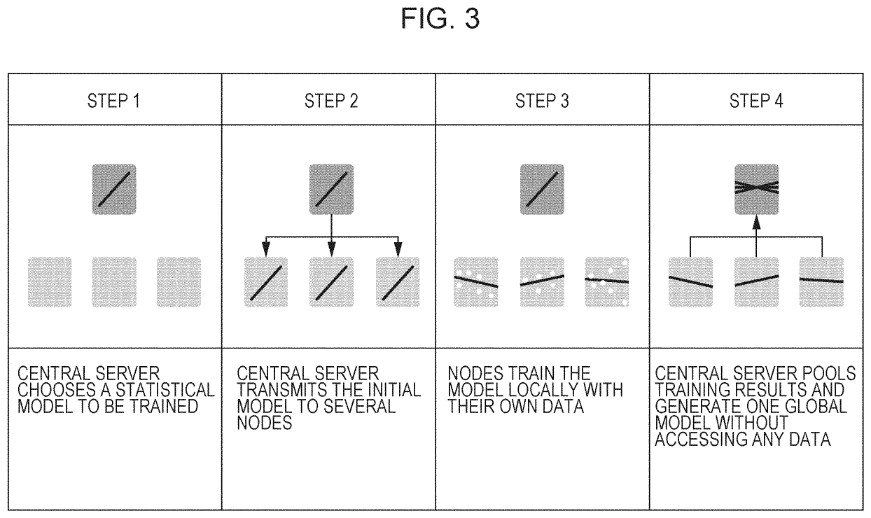

FIGS. 3-6 are conceptual diagrams of the FL mechanism according to one or more embodiments.

FIG. 3 illustrates an example workflow of the FL mechanism. In one or more embodiments, a central server (e.g., the cloud server 100) chooses a statistical model as an initial model (e.g., the common ML model) to be trained by the common global dataset. (Step 1). Then the central server transmits the initially pre-trained common ML model to the edge devices 200A-200C and/or the edge server 300 for real-time operation (Step 2). Each of the nodes (e.g., the edge devices/servers) further trains the initial model locally with their own local dataset (Step 3), and the parts of the locally trained models (e.g., the key parameters of the optimization models) are returned to the central server. The central server pools the parts of the locally trained models and generates one updated global model (e.g., the updated common ML model) without accessing any other data (Step 4).

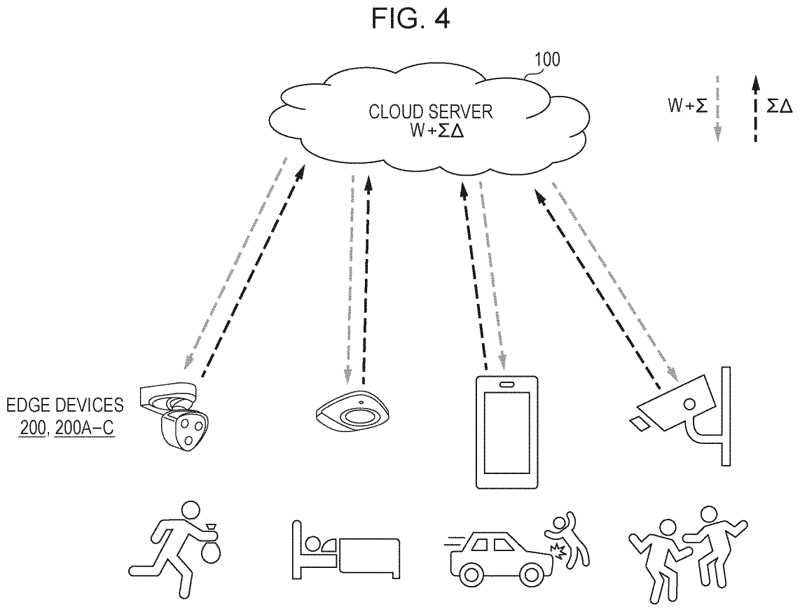

FIG. 4 illustrates an example process cycle of the FL mechanism according to one or more embodiments. As shown in FIG. 4, the cloud server 100 first distributes the pretrained common ML model to the edge devices 200A-200C, collects the key parameter(s) indicated as a change amount(s) (Δ or ΣΔ) from each of the edge devices 200A-200C, after local optimization of the common ML model, and stores the total sum of the key parameters (ΣΔ). The cloud server 100 also stores a weight (W) of the common ML model which is a parameter of the NN or DNN and applied or multiplied to input data in a hidden layer of the NN or DNN. In one or more embodiments, the cloud server 100 may also utilize, similarly to the weight, a bias (B) which is a parameter of the NN or DNN and added to input data in the hidden layer. The cloud server 100 updates the common ML model with the total sum of the key parameters (ΣΔ), and then sends the updated common ML model including the weight and the key parameters (W+ΣΔ) to each of the edge devices 200A-200C. By repeatedly reflecting the key parameters (ΣΔ), the common ML model is continuously improved. The cloud server 100 may repeat this cycle until meeting customers' goals of most appropriate image analysis.

By collecting only the key parameters, the cloud server 100 can significantly reduce a communication load and save an amount of data to be stored in the storage 120. Further, by returning only the key parameter(s), the edge devices 200A-200C can rapidly response to the request from the cloud server 100. The edge devices 200A-200C also do not need to share their own data, which can protect data privacy, data security, and data access rights.

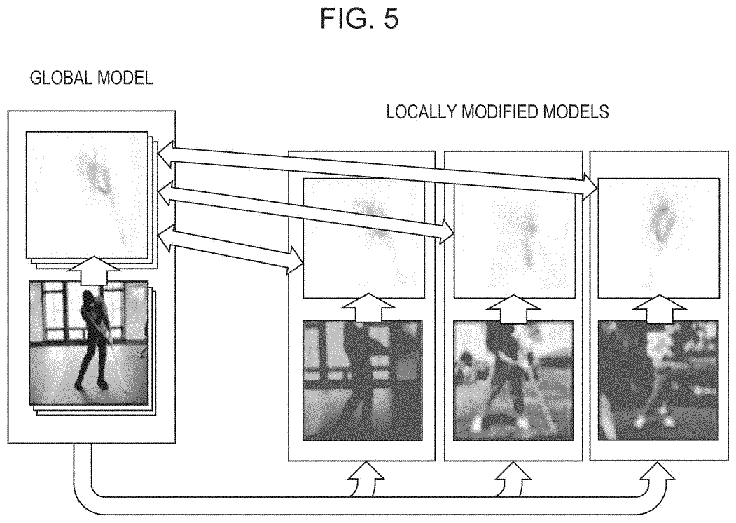

FIG. 5 illustrates an example process flow of the FL mechanism for video image analysis. The cloud server 100 firstly creates a “Global Model,” as the common ML model, from RGB video clips of golf swing practice with the optical flows as the key parameters. The common ML model is distributed to each of the edge devices 200A-200C and/or the edge server 300 and locally optimized using local RGB video clips to obtain “Locally Modified Models,” as the locally optimized common ML models. Then the edge devices 200A-200C and/or the edge server 300 return only the locally optimized optical flows, and the cloud server 100 updates “Global Model” using the returned locally optimized optical flows from the edge devices 200A-200C and/or the edge server 300. The cloud server 100 may repeat this process till the “Global Model” meets a predetermined desired value.

In the case where the image analysis is the video image analysis for object detection and motion tracking, the common ML model is optimized to overcome heterogeneities (e.g., variation in size and/or motion) of the visual data locally obtained.

To improve image analysis accuracy, a developed DNN computer vision (CV) algorithm, such as Image Net and Region-based Convolutional Neural Network, may be used. Although advanced CV algorithm intends to create and monitor bounding boxes of objects from an input image, to process a real-time input of video images, most implementations of this algorithm only address relationships of objects within the same frame disregarding time information.

An optical flow (i.e., a tool in computer vision introduced to describe a visual perception of human by stimulus objects) can address this issue. The optical flow may be the pattern of apparent motion of the object between the consecutive video frames caused by a relative movement between the object and the sensing device, and is capable of creating relationships between the consecutive video frames. For example, the optical flow is capable of tracking a motion of vehicle across the consecutive video frames, and recognizing a human action in the consecutive video frames. Since only the optical flow is modified for optimization/customization for local usage in the FL mechanism, the DNN computer vision algorithm is used without major modification/customization for the optimization/customization.

In one or more embodiments, the common ML model for real-time object detection and motion tracking may contain a conventional DNN computer vision algorithm from opensource (e.g., Open Source Computer Vision Library (OpenCV) and kornia). Although a sparse optical flow that analyzes characteristic points within an image is utilized as the optical flow in the edge devices 200A-200C and/or the edge server 300 of one or more embodiments, it is also possible to utilize a dense optical flow that analyses pixel motions in an entire image.

In one or more embodiments, the common ML model may be pretrained or trained by an open-source video dataset, such as YouTube-8M Segments Dataset or 20BN-Something-Something Dataset V2.

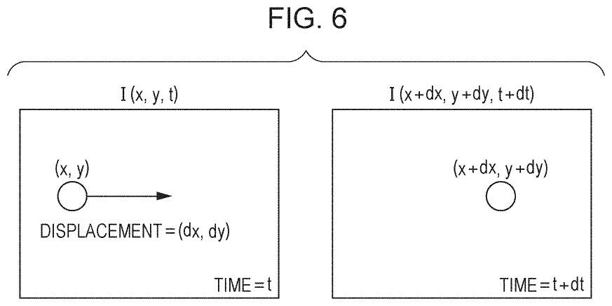

FIG. 6 illustrates an example optical flow between the consecutive video frames. In FIG. 6, “(x, y)” indicates a coordinate position of a pixel and “I (x, y, t)” indicates a pixel intensity in a first video frame captured at time “(t).” In a second video frame captured at time “(t+dt),” the coordinate position of the pixel shifts to “(x+dx, y+dy),” and the pixel intensity can be presented as “I (x+dx, y+dy, t+dt).” Since the pixel intensity does not change between the first and second video frames, a motion vector (u, v) can be obtained from “ I (x, y, t)” and “I (x+dx, y+dy, t+dt)” for the pixel in a two-dimensional plane.

Optimization of the image analysis can be achieved by estimating the motion vectors from regions of interest of the video frames in different timeline. Motion vectors are defined by the relative velocity between object and observer. The standard method of estimating the motion vectors is least square estimation using Singular Value Decomposition (SVD).

Two recently developed open-source deep learning (DL) algorithms for motion estimation using optical flows are as follows: FlowNet is the first convolutional neural network (CNN) approach for calculating optical flows, and Recurrent All-Pairs Field Transforms (RAFT) is the current state-of-the-art method for estimating optical flows. The local business partners and/or customers can select the most suitable DNN algorithm for optimization of their specific video action analysis using local video dataset and return the optical flow to further optimize the computer vision algorithm (i.e., the common ML model) in the imaging IoT platform.

### FL Method for Building Robust Building Common ML Model

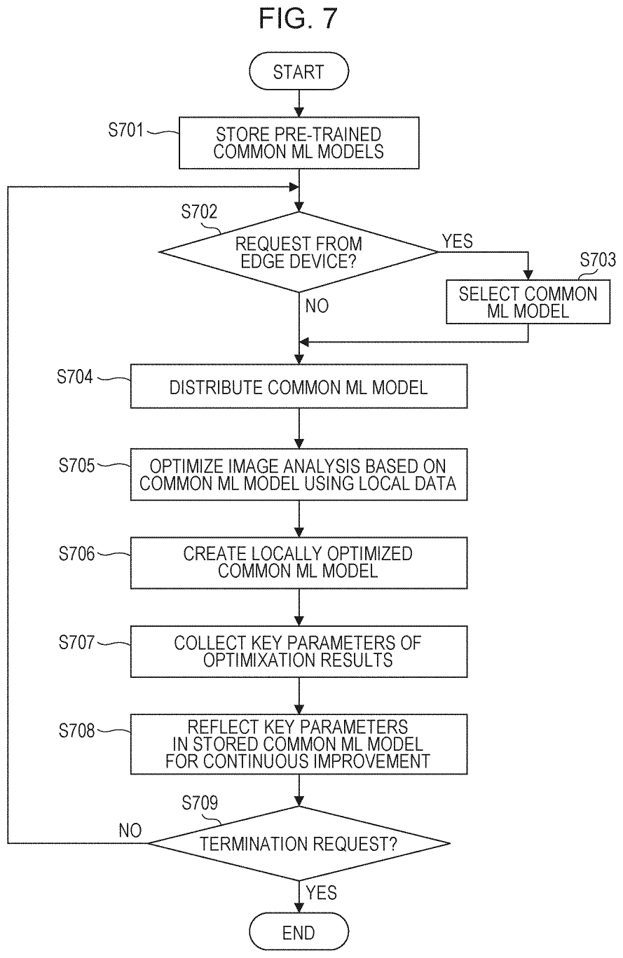

The FL method for building the robust common ML model will be described with reference to the flowchart of FIG. 7. One or more of the steps in FIG. 7 may be performed by the components of the IoT system 1000, discussed above in reference to FIGS. 1-2. In one or more embodiments, one or more of the steps shown in FIG. 7 may be omitted, repeated, and/or performed in a different order than the order shown in FIG. 7. Accordingly, the scope of the invention should not be considered limited to the specific arrangement of steps shown in FIG. 7.

The could server 100 pretrains the common ML models available within the network 500 using a predetermined dataset (e.g., RGB video clips), and stores the pretrained common ML models in the storage 120 (Step S701).

The could server 100 determines whether the request has been received from at least one of the edge devices 200A-200C and the edge server 300 at a predetermined timing (Step S702). For example, the cloud server 100 may make the determination periodically or at the timing of receiving the request.

When determining that the request has been received (Step S702: Yes), the cloud server 100 selects, from among the common ML models, a common ML model associated with the request (Step S703). In one or more embodiments, the storage 120 may previously store the association between the common ML model and the request and/or between the common ML model and the image analysis executed in the edge devices 200A-200C and/or the edge server 300. Alternatively, the request may contain information identifying a certain common ML model to be distributed.

After selecting the common ML model (Step S703), or when determining that the request has been received (Step S702: No), the cloud server 100 distributes the common ML model to the edge devices 200A-200C and/or the edge server 300 (S704).

Based on the common ML model, the edge devices 200A-200C and/or the edge server 300 optimize the image analysis using the local data (Step S705), and create the locally optimized common ML models (Step S706).

The could server 100 collects the key parameters of the optimization results from the edge devices 200A-200C and/or the edge server 300 (S707).

Upon collecting the key parameters, the could server 100 reflects the key parameters in the common ML model stored in the storage 120 for continuous improvement (S708).

The cloud server 100 checks whether a termination request has been received from any of the edge devices 200A-200C, the edge server 300, or other devices/apparatus within the network 500 periodically or at the timing of receiving the termination request (S709). Upon determining that the termination request has been received (S709: Yes), the cloud server 100 terminates the process. Alternatively, the cloud server 100 may terminates the process when a predetermined time period has been passed.

Upon determining that the termination request has not been received (S709: No), the process returns to Step 702 and the above cycle is repeated.

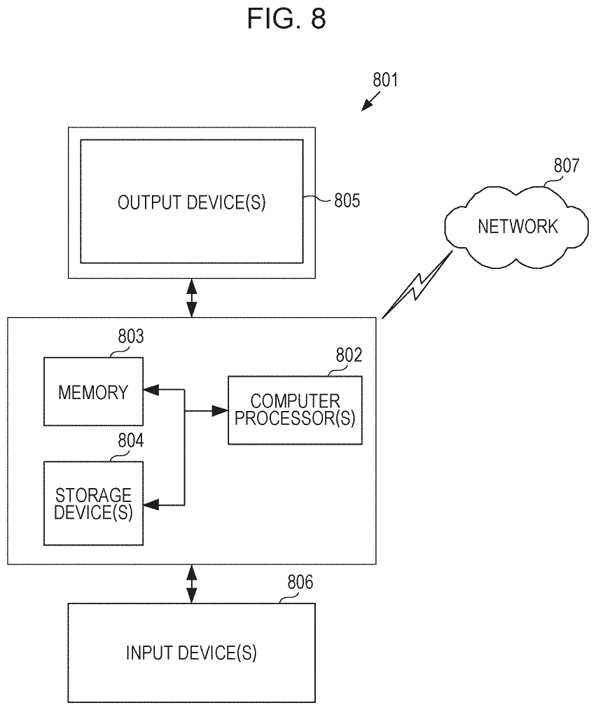

Embodiments of the invention may be implemented on virtually any type of computing system, regardless of the platform being used. For example, the computing system may be one or more mobile devices (e.g., laptop computer, smartphone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 8, the computing system (801) may include one or more computer processor(s) (802), associated memory (803) (e.g., random access memory (RAM), cache memory, flash memory, etc.), one or more storage device(s) (804) (e.g., a hard disk, an optical drive such as a compact disk (CD) drive or digital versatile disk (DVD) drive, a flash memory stick, etc.), and numerous other elements and functionalities. The computer processor(s) (802) may be an integrated circuit for processing instructions. For example, the computer processor(s) may be one or more cores, or micro-cores of a processor. The computing system (801) may also include one or more input device(s) (806), such as a touchscreen, keyboard, mouse, microphone, touchpad, electronic pen, or any other type of input device. Further, the computing system (801) may include one or more output device(s) (805), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (801) may be connected to a network (807) (e.g., a local area network (LAN), a wide area network (WAN) such as the Internet, mobile network, or any other type of network) via a network interface connection (not shown). The input and output device(s) may be locally or remotely (e.g., via the network (807)) connected to the computer processor(s) (802), memory (803), and storage device(s) (804). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (801) may be located at a remote location and connected to the other elements over a network (807). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The imaging IoT platform implemented with the IoT system of one or more embodiments provide various improvements to image analysis technologies. For example, the IoT system enables contactless, remote, and real-time responses from the edge devices/servers in various types of business in fields of image analysis, and realizes the FL mechanism with the robust common ML model by continuously improve the common ML model while protecting data privacy of the edge devices/servers.

According to one or more embodiments, collecting only the key parameters without centrally collecting large data can significantly reduce the communication load and save the amount of data to be stored, which reduces equipment costs. Further, the edge devices/servers can rapidly response to the request from the cloud server 100, and do not need to share their own data among the edge devices/servers, which can built highly distributed platform while protecting the data privacy, data security, and data access rights.

According to one or more embodiments, selection of the most suitable common ML model to be distributed enables further optimization of the computer vision algorithm and more appropriate image analysis to meet business partners' and customers' accuracy goals.

According to one or more embodiments, by collaborating the DNN computer algorithm, the Imaging IoT platform with very high performance can be provided.

According to one or more embodiments, by distributing the down-sized common ML model to the edge device having a relatively small data capacity and distributing the common ML model without downsizing to the edge server having a relatively large data capacity, the imaging IoT platform can be scalable.

Although the disclosure has been described with respect to only a limited number of embodiments, those skilled in the art, having benefit of this disclosure, will appreciate that various other embodiments may be devised without departing from the scope. Accordingly, the scope of the invention should be limited only by the attached claims.

1. A cloud server connected to a plurality of edge devices via a network, the cloud server comprising:
a storage that stores a common machine learning (ML) model that is pretrained and used for optimizing image analysis; and
a processor that repeatedly executes:
distributing the common ML model to each of the edge devices that optimize the image analysis using local data and that modify the common ML model to create a locally optimized ML model,
collecting a key parameter of an optimization result, without collecting the locally optimized ML model or accessing the local data, from each of the edge devices, and
updating the common ML model stored in the storage by reflecting the key parameter in the common ML model at a predetermined timing to continuously improve the common ML model for more accurate image analysis.

2. The cloud server according to claim 1, wherein
the storage stores different kinds of common ML models including the common ML model, and
in response to a request from one of the edge devices, the processor selects one of the common ML models to be distributed depending on the image analysis executed in the one of the edge devices.

3. The cloud server according to claim 1, wherein
the image analysis is video image analysis for real-time object detection and motion tracking, and
the common ML model is a deep neural network (DNN) computer vision algorithm.

4. The cloud server according to claim 1, wherein
the key parameter includes an optical flow obtained from consecutive video frames when the locally optimized ML model is created.

5. The cloud server according to claim 1, wherein
the cloud server is further connected to an edge server that has a larger data capacity than a data capacity of each of the edge devices and that executes image analysis via the network, and
the processor distributes, as the common ML model, a down-sized common ML model to each of the edge devices, while distributing the common ML model without downsizing to the edge server.

6. A non-transitory computer readable medium (CRM) storing computer readable program code executed by a computer as a cloud server being connected to a plurality of edge devices via a network, and the program code causing the computer to execute:
storing, in a storage, a common machine learning (ML) model that is pretrained and used for optimizing image analysis; and
repeatedly executing:
distributing the common ML model to each of the edge devices that optimize the image analysis using local data and modify the common ML model to create a locally optimized ML model,
collecting a key parameter of an optimization result, without collecting the locally optimized ML model or accessing the local data, from each of the edge devices, and
updating the common ML model stored in the storage by reflecting the key parameter in the common ML model at a predetermined timing to continuously improve the common ML model for more accurate image analysis.

7. The CRM according to claim 6, wherein
the computer further executes:
storing different kinds of common ML models including the common ML model, and
in response to a request from one of the edge devices, selecting one of the common ML models to be distributed depending on the image analysis executed in the one of the edge devices.

8. The CRM according to claim 6, wherein
the image analysis is video image analysis for real-time object detection and motion tracking, and
the common ML model is a deep neural network (DNN) computer vision algorithm.

9. The CRM according to claim 6, wherein
the key parameter includes an optical flow obtained from consecutive video frames when the locally optimized ML model is created.

10. The CRM according to claim 6, wherein
the cloud server is further connected to an edge server that has a larger data capacity than a data capacity of each of the edge devices and that executes image analysis via the network, and
the computer further executes:
distributing, as the common ML model, a down-sized common ML model to each of the edge devices, while distributing the common ML model without downsizing to the edge server.

11. A federated learning (FL) method using a cloud server being connected to a plurality of edge devices via a network, the method comprising:
storing, in a storage, a common machine learning (ML) model that is pretrained and used for optimizing image analysis; and
repeatedly executing:
distributing the common ML model to each of the edge devices that optimize the image analysis using local data and modify the common ML model to create a locally optimized ML model,
collecting a key parameter of an optimization result, without collecting the locally optimized ML model or accessing the local data, from each of the edge devices, and
updating the common ML model stored in the storage by reflecting the key parameter in the common ML model at a predetermined timing to continuously improve the common ML model for more accurate image analysis.

12. The FL method according to claim 11, wherein
the storing includes storing different kinds of common ML models including the common ML model, and
the distributing includes, in response to a request from one of the edge devices, selecting one of the common ML models to be distributed depending on the image analysis executed in the one of the edge devices.

13. The FL method according to claim 11, wherein
the image analysis is video image analysis for real-time object detection and motion tracking, and
the common ML model is a deep neural network (DNN) computer vision algorithm.

14. The FL method according to claim 11, wherein
the key parameter includes an optical flow obtained from consecutive video frames when the locally optimized ML model is created.

15. The FL method according to claim 11, wherein
the cloud server is further connected to an edge server that has a larger data capacity than a data capacity of each of the edge devices and that executes image analysis via the network, and
the distributing includes:
distributing, as the common ML model, a down-sized common ML model to each of the edge devices, while distributing the common ML model without downsizing to the edge server.
